(19) United States
(12) Patent Application Publication
(10) Pub. No.: US 2024/0412311 A1
(43) Pub. Date: Dec. 12, 2024

(54) NOTARIZATION MOBILE APPLICATION SYSTEM AND METHOD

(71) Applicant: Alvaro Alberto Bautista, Pico Rivera, CA (US)

(72) Inventor: Alvaro Alberto Bautista, Pico Rivera, CA (US)

(21) Appl. No.: 18/807,586

(22) Filed: Aug. 16, 2024

Related U.S. Application Data
(63) Continuation-in-part of application No. 18/186,002, filed on Mar. 17, 2023, now abandoned.
Application No. 18/186,002 is a division of application No. 17/166,620, filed on Feb. 3, 2021, now abandoned.
(60) Provisional application No. 63/021,857, filed on May 8, 2020.

(51) Int. Cl. G06Q 50/18; G06F 3/12; G06F 21/32; G06K 1/12; G06K 19/06; G06Q 10/10; G06Q 20/20; G06Q 30/018; G06Q 50/26; G06T 11/20; G06V 30/40; G06V 40/12; G06V 40/13; G06V 40/16

(52) U.S. Cl. CPC G06Q 50/18; G06F 3/1222; G06F 3/1238; G06F 3/1292; G06F 21/32; G06K 1/121; G06K 19/06028; G06Q 10/10; G06Q 20/204; G06Q 20/209; G06Q 30/0185; G06Q 50/265; G06T 11/203; G06V 30/40; G06V 40/1318; G06V 40/1365; G06V 40/172

(57) ABSTRACT

A notarization system for use in notarizing a document, the system comprising: a handheld notarization device having a printer; and a notarization application configured to be accessible only by a primary user and to operate on a mobile device having a camera, the notarization application being programmed to digitally read identification information from an identification card of a secondary user received via the camera, such that to verify the identity of the secondary user and authenticate the identification card, digitally scan and generate a digital line drawing of a fingerprint of the secondary user received via the camera, digitally generate a notarization endorsement and cause a printing of the notarization endorsement onto a tamper-resistant sticker via the printer, wherein, when the notarization application is being accessed by the primary user, and upon signing of the document by the secondary user, the notarization application causes a printing of the notarization endorsement.

### CROSS-REFERENCE TO RELATED APPLICATIONS

This application claims priority to and is a continuation-in-part of U.S. Non-Provisional application Ser. No. 18/186,002, filed Mar. 17, 2023, which is a divisional of U.S. Non-Provisional application Ser. No. 17/166,620, filed Feb. 3, 2021, which claims the benefit of U.S. Provisional Application No. 63/021,857, filed May 8, 2020, each of which are hereby incorporated by reference, to the extent that they are not conflicting with the present application.

### BACKGROUND OF INVENTION

### 1. Field of the Invention

The invention relates generally to notarization and the prevention of notary fraud, and more specifically to using a mobile application system and method for notary and signer verifications to prevent notary fraud.

### 2. Description of the Related Art

A notary or notary public, as is known in the art, is an individual who acts as a third-party witness having no personal stake in a given transaction. The notary has the duty of noting, through the notary's signature and stamp, that a signer of a document understands the importance of the document, that the signature belongs to the signer, and that the document was signed willingly.

As described above, notarization of a document requires the witnessing of a signature and a verification of the signer's identity (via a passport or driver's license, for example). As such, the notarization process is currently mostly performed in person at banks, legal offices, notary centers, etc., for the notary to personally issue a notary stamp and their signature, and to record the occurrence of the notarization in their journal/log.

However, issues of malpractice may occur during the notarization process, as evidenced by the growing problem of notary fraud. Notary fraud, which may be committed on the part of the notary or the signer/signatory, may refer to the failure to acknowledge a document, the failure to verify the identity of the signer/signee, the falsification of notary stamps and/or signatures, and/or the allowance of the signer to sign a document while the notary is not present. Instances of notary fraud may be difficult to detect, especially instances of falsifying notary stamps since many types of notary stamps are used. Additionally, notary stamps applied electronically and/or sent via email can be difficult to verify and must be approved by the particular state in which the notarization occurred. In short, there are few metrics in place to ensure the notary's work is held accountable.

Moreover, instances of identity theft may be committed against a signer/signee by a false or unverified notary, or vice versa, by a signer/signee using a false or stolen identity during the notarization process. Instances of fraud may occur after the notarization process as well, such as the forging of notarized documents by altering/editing the originally notarized documents. No centralized and secured database currently exists for storing any and all notarized documents, rendering the verification of a seemingly legitimate notarized document challenging without access to the notary's personal journal/log.

Therefore, there is a need to solve the problems described above by providing a system and method for electronically notarizing documents in a verified and secure manner and allowing for such notarized documents to be securely archived and later retrieved by an authorized user.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a notarization system for use in notarizing a document is provided. The notarization system may comprise: a handheld notarization device having a printer; and a notarization application configured to be accessible only by a primary user and to operate on a mobile device, the mobile device being in electrical communication with the notarization device, the notarization application being programmed to digitally read identification information from an identification card of a secondary user scanned via a camera of the mobile device, such that to verify the identity of the secondary user and authenticate the identification card, digitally scan and generate a digital line drawing of a fingerprint of the secondary user received via the camera, and digitally generate a notarization endorsement and cause a printing of the notarization endorsement onto a tamper-resistant sticker via the printer; and wherein, when the notarization application is being accessed by the primary user for notarizing the document, and upon signing of the document by the verified secondary user, the notarization application causes a printing of a notarization endorsement onto the tamper-resistant sticker for placement onto the signed document, the notarization endorsement officiating the notarization of the signed document. Thus, an advantage is that the notarization device may be lightweight and easy to carry around, providing the notary with free mobility during use, and thus easy retrieval for use during the notarization process. An additional advantage is the ease of incorporation of the notarization device and notarization program with existing wireless devices, which may thus reduce operational costs.

In another aspect, a method of notarizing a document to be signed by a signer using a notarization system is provided, the notarization system comprising a notarization device and a notarization application operating on a mobile device. The method may comprise the steps of: providing the notarization system with a biometric identifier and a notary license for identification verification and notary license validation; accessing the notarization application following the identification verification and notary license validation, and classifying the document via the notarization application, such that to assign a unique barcode to the document being notarized; capturing a photograph of the signer using a camera of the mobile device for digital recordation; obtaining a fingerprint scan from the signer using the camera for digital recordation; obtaining an identification card from the signer for digital verification via the notarization application; visually verifying and witnessing the signing of the document by the signer, such that to notarize the document, and confirming the notarization with the notarization application; and associating a notary endorsement sticker printed by the notarization device with the signed document, the notary endorsement sticker officiating the notarization of the signed document. Thus, an advantage is that the notarization device may be lightweight and easy to carry around, providing the notary with free mobility during use, and thus easy retrieval for use during the notarization process. Another advantage is that the notary may accomplish multiple tasks in accordance with the notarization process using a single, compact device. An additional advantage is the ease of incorporation of the notarization device and notarization program with existing wireless devices, which may thus reduce operational costs. Another advantage is that the signer's identity may be automatically verified using the disclosed method, which may prevent instances of notary fraud.

In another aspect, a method of assisting a notary with the notarization of a document is provided, the method comprising providing a notarization application having an electronic log (e-log). The notarization application may be programmed to: verify the identity of the notary using a biometric identifier received via an operating device and validate a notary license number of the notary; verify the identity of a signer by digitally reading and extracting identification information from an identification card of the signer, the identification card being received via the operating device, the extracted identification information being electronically stored in the e-log; digitally scan and generate a digital image of a fingerprint of the signer, the fingerprint being received via the operating device, the digital image being electronically stored in the e-log; digitally generate a notarization endorsement and cause a printing of the notarization endorsement onto a tamper-resistant sticker via an external device; and digitally generate a certificate of notarization certifying a date on, a location at, and a time at which the notarization occurred. Thus, an advantage is that the signer's identity may be automatically verified using the disclosed method, which may prevent instances of notary fraud. An additional advantage is the reduction in cases of notary fraud due to improved, instant third-party verification of notary and signer identities. Because the notarization program automatically generates the notary endorsement and the notarization certification, another advantage is the addition of fail safes to the overall notarization process.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 is a schematic diagram depicting a system for secure notary systems, according to an aspect.

FIG. 2 is a schematic diagram depicting a plurality of partitions within the centralized database 101 of the secure notary system, according to an aspect.

FIG. 3A is a schematic diagram depicting a process for verification of notary users of the secure notary system, according to an aspect.

FIG. 3B is an exemplary screenshot depicting a method of verifying a person's identity using the secure notary system mobile application, according to an aspect.

FIGS. 3C-3D depict steps of an exemplary process for verification of a person's identification documents, according to an aspect.

FIG. 4A is an exemplary blank notary endorsement, according to an aspect.

FIG. 4B is an exemplary preview of a notary endorsement generated by an auto-notarizing mobile application, according to an aspect.

FIG. 4C is an exemplary sticker illustrating a finalized notary endorsement, generated by the auto-notarizing mobile application, of that shown in FIG. 4B, according to an aspect.

FIG. 5A illustrates a perspective view of an exemplary notarization device, according to an aspect.

FIG. 5B illustrates a front perspective view of an exemplary notarization device connected wirelessly to a mobile device, according to an aspect.

FIGS. 6A-6B are flowcharts illustrating the auto-notarizing mobile application process steps of notarizing a document, according to several aspects.

FIGS. 7A-70 are exemplary screenshots illustrating a method of notarizing a document using the auto-notarizing mobile application described in FIGS. 6A-6B, according to an aspect.

FIG. 8 illustrates a front perspective view of an alternative embodiment of the notarization device 440, provided as an attachment for a mobile device, according to an aspect.

FIG. 9 is a depiction of an exemplary process for verification of a person's identity using the secure notary system, according to an aspect.

FIGS. 10A-10B show exemplary screenshots and documents relating to a biometric verification process using an application for the secure notary system, according to an aspect.

FIG. 11 shows an exemplary process for using barcodes with the secure notary system, according to an aspect.

FIGS. 12A-12B depict various examples of barcodes that may be used for documents notarized with the secure notary system, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures (e.g., 110 and 210, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

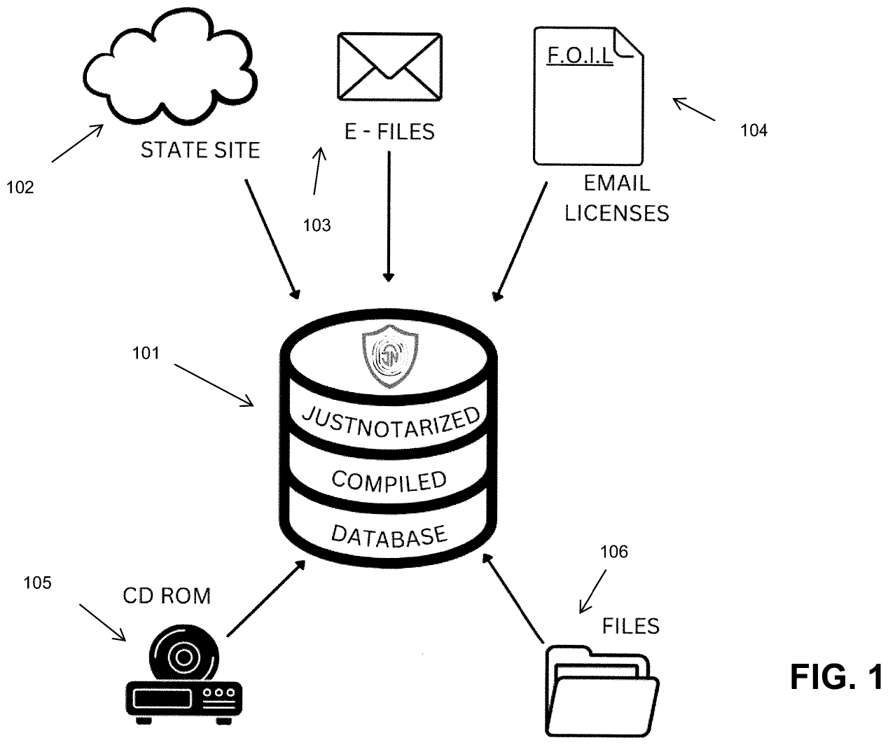

FIG. 1 is a schematic diagram depicting a system for secure notary systems, according to an aspect. Provided herein are systems and methods relating to software for use in notarial processes. Generally, the software herein may be referred to herein as “software for notarial processes,” “notary software,” or generally “software.” Provided herein are systems and methods for secure notary systems. In some embodiments, technology is provided to authenticate real and valid information relating to a person's identity. In such embodiments, video capture with liveness detection may be used to identify and compare a user to a presented identification document. In some embodiments, original documents are stored at the time of signing. Such documents may be securely stored using a suitable tamper evident storage system.

Also provided herein is an application (“notarization mobile application,” “auto-notarizing mobile application,” “auto-notarizing program,” “notarization program,” “JustNotarized app”), for accessing the software via devices such as smartphones, tablets, or any other suitable device. Generally, the software, application, and processes and components relating to such may be referred to as a “secure notary system.” In some embodiments, notaries are manually vetted prior to their being given access to the application. In some embodiments, an application accessible by an electronic device such as a smartphone may be provided for accessing the secure notary system. In some embodiments, the app may produce a unique barcoded label for each notarization activity. In such embodiments, the barcode may help to ensure authenticity and may also allow for document review in the future. It should be understood that generally the functions of the secure notary system could be carried out by users by accessing the application, which could be done via a mobile device, smart phone, tablet, or any other suitable device. In such embodiments, processes such as scanning, imaging, and verification of a person's identity can all be carried out through the application.

The secure notary systems disclosed herein may include a compiled database 101 (also referred to herein as a “centralized database”) for storage of all necessary information relating to securing a notarial process. In some embodiments, the secure notary system may include notary databases, which may be compiled for each U.S. state. For example, information from state government websites 102 or the like may be used for compiling information to be stored in the compiled database 101. The compiled database 101 may therefore be used for storing information pulled from state sites 102, and other sources such as, but not limited to, e-files 103, email licenses 104, CD-ROMs 105 or any other suitable physical media, and any other suitable general files 106. In some embodiments, each state compiles its own database for use in the secure notary system. In some embodiments, the following databases and systems are provided in the secure notary system: a downloadable database, which is readily available online with all notary licenses, a searchable database wherein each notary could be manually searched for, databases by request, wherein such databases are accessible online and through which individual license status can be requested, a system for email requests wherein license information is sent via email to a management center for the secure notary system, and a system for traditional paper mail wherein files are mailed to a management center for the secure notary system, including, but not limited to, notary license information on physical media such as discs, USB drives, or on paper. Generally, a management center for the secure notary system could compile the complete databases for the system using any and all information that is received.

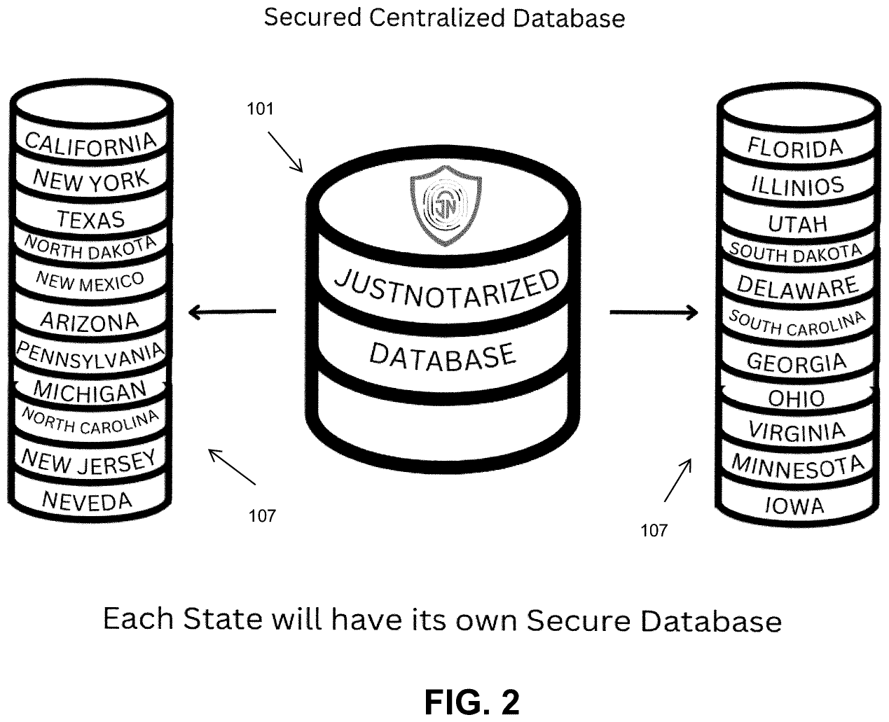

FIG. 2 is a schematic diagram depicting a plurality of partitions within the centralized database 101 of the secure notary system, according to an aspect. The system is configured to follow each U.S. state's notary laws and code, and accordingly can be configured to be compliant within each state when carrying out processes related to notary procedures. In some embodiments, each U.S. state has access to its own unique and separate database for storage purposes. Accordingly, the secure notary system compiled database 101 may comprise partitions or sections each U.S. state for which it contains specialized information. FIG. 2 depicts a plurality of exemplary partitioned sub-databases (also referred to herein as “partitions”) 107.

Each partition may be designated for a single U.S. state, for example. Each partitioned sub-database may have restricted access, such that a particular user may be authorized to access information from a certain partition while being restricted from accessing information from other partitions. In some embodiments, a user is granted access to only some of the partitions within the centralized database 101. In some embodiments, a user is granted access to each of the partitions within the centralized database 101.

In some embodiments, further partitions are provided for storing information relating to notarial processes, such as, for example: digital images of fingerprints, and images of certifications of a notarization including seals, dates, time and location, and so on.

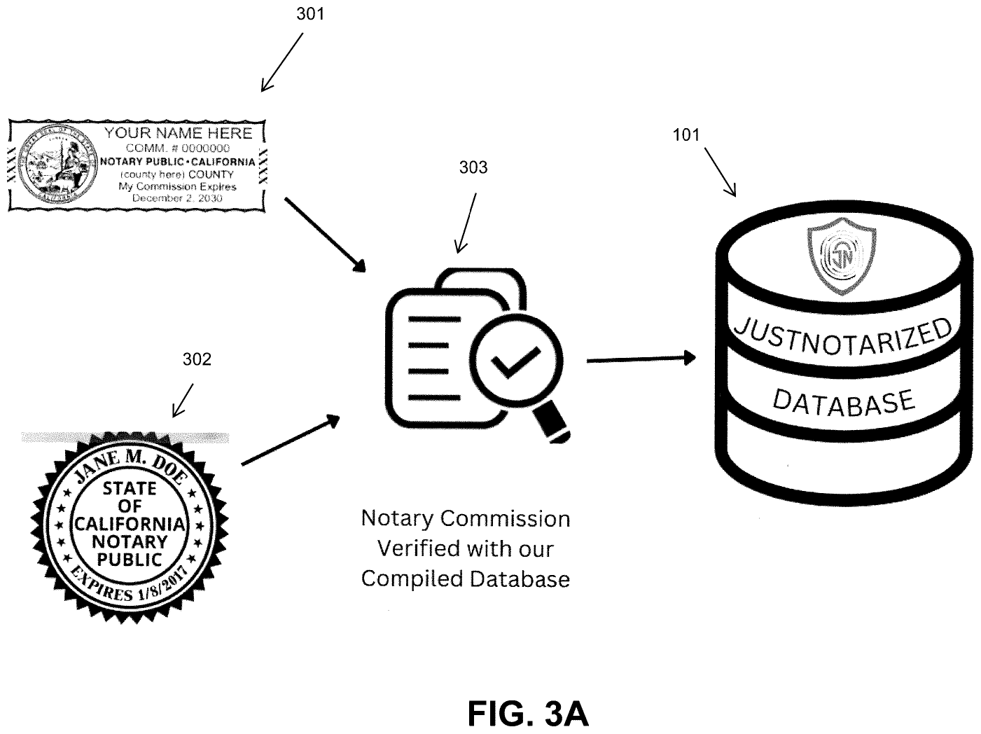

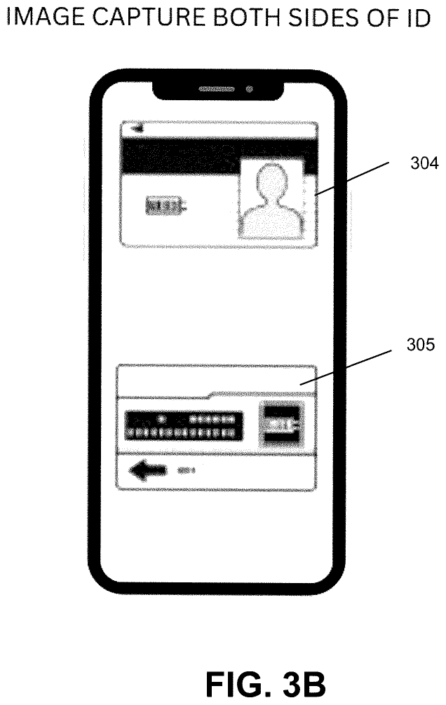

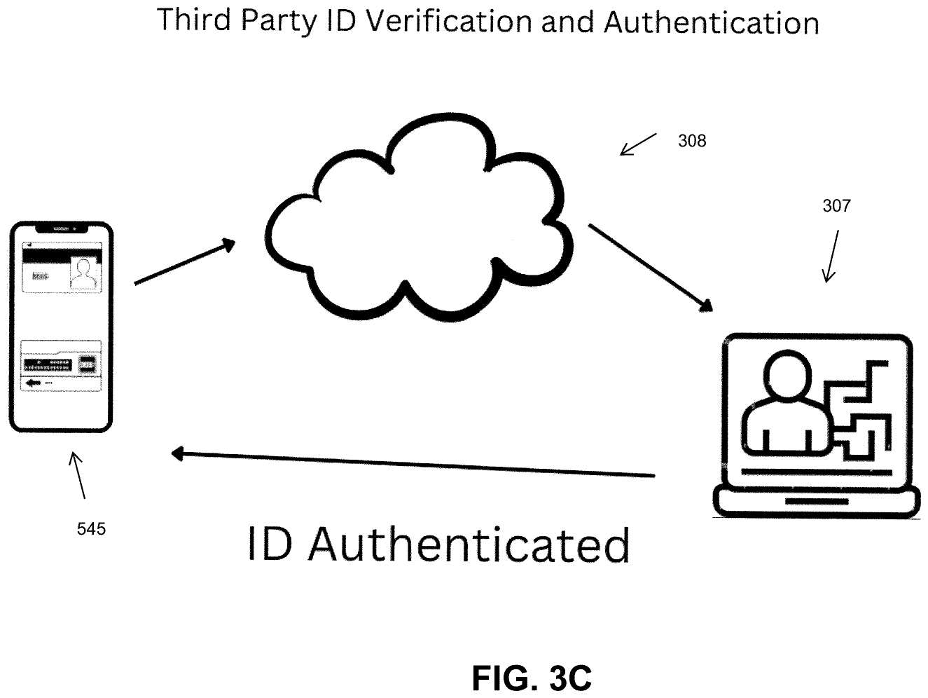

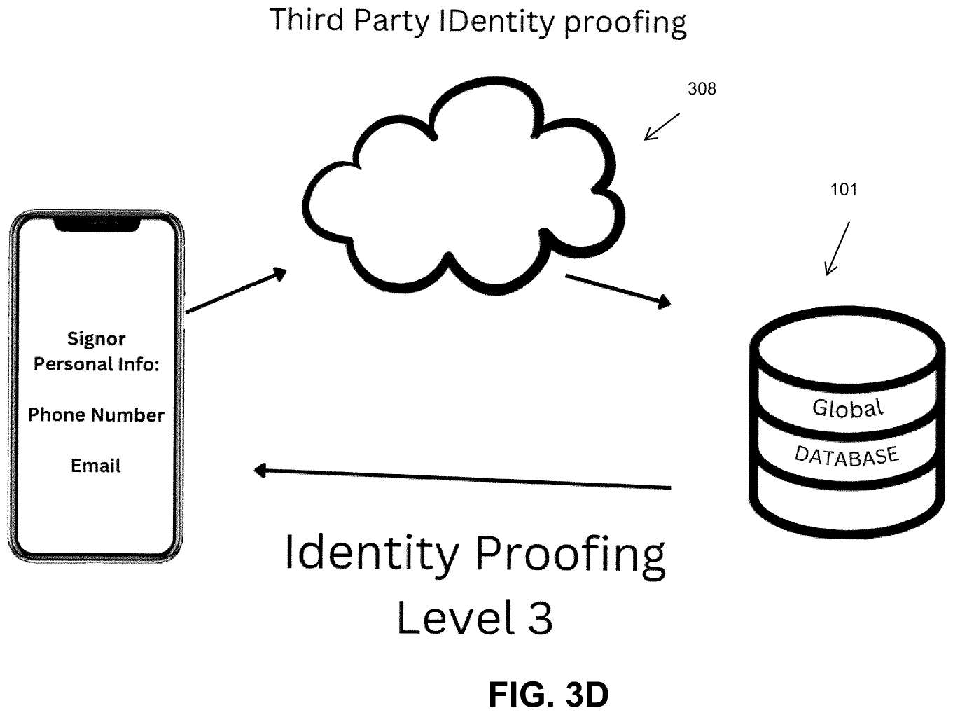

FIG. 3A is a schematic diagram depicting a process for verification of notary users of the secure notary system, according to an aspect. In some embodiments, the system is available by subscription to licensed notary publics. That is, a notary must hold a valid notary commission issued by their U.S. state of licensing, prior to being able to access the system. The notary's identification is verified for authenticity. The notary's commission and information are manually reviewed. Generally, once a notary's license has been verified through the secure notary system and their notary commission information is uploaded into the database of the system, the management center for the secure notary system manually verifies each individual. This is advantageous to ensure that each notary is qualified to perform notarizations before being given access to the application for the system.

In some embodiments, notaries may be manually vetted, with their license status verified, prior to their use of the secure notary system. In some embodiments, biometric access may be used to ensure that the person accessing the secure notary system is the authorized notary. For example, the application used to access the system may require an image of a user's identification document, which is then compared to those stored in the database. A live person of the management center for the secure notary system can ensure that the stamp and commission certificate are true and correct before allowing a potential notary user on board. Generally, with the information stored in the centralized database 101 as discussed when referring to FIG. 1, and the state-specific information stored in the various partitions 107 of the centralized database as discussed when referring to FIG. 2, the secure notary system can include all necessary information for verifying the identity of a notary, or other user. Accordingly, notaries may be verified against the information stored on the centralized database 101 prior to onboarding of use of the application, and before each use of the application. In some embodiments, each U.S. state may offer different access to notary information, such as, for example, online information, email, and files on discs. In some embodiments, different states may have different requirements for requesting of notary information. For example, the state of Florida may require for the management center of the secure notary system to request notary license files through email or phone calls, before information is then sent on CD-ROM with the information. Therefore, the system may be configured to receive information from various media. In some embodiments, the secure notary system includes a compiled uniform database.

In some embodiments, a notary's commission information 301 and license status 302 can be verified in any suitable process 303 against the information stored in the centralized database 101. Generally, the application accessible on a user's mobile device, or other suitable device, can automatically verify a notary user's status upon the opening of the application. In some embodiments, once a notary is vetted and the application is installed for use by the authorized notary, the system will verify the notary's identity via their device's biometrics before access to the application is granted. The notary's commission/license status will be verified against the system's notary database, compiled from the most current information available. Generally, the database is updated as frequently as possible. In some embodiments, the database is updated daily. In some embodiments, updates are performed automatically, in cases of information from states that allow the management center of the system open access online to its information. In some embodiments, updates are performed on a weekly basis. In some embodiments, updates are performed periodically as circumstances allow, such as monthly, with consideration of each state's individual guidelines and requirements.

FIG. 3B is an exemplary screenshot depicting a method of verifying a person's identity using the secure notary system mobile application, according to an aspect. A notary or signer may have their identity verified by the system by use of an image capture function of the application. In such embodiments, a front side 304 and a back side 305 of an identification card or other document such as a driver's license may be captured. Identification documents may be, for example, driver's licenses, passports, and the like. The system can also scan and verify digital identification documents as well as RFID chips, for example.

FIGS. 3C-3D depict steps of an exemplary process for verification of a person's identification documents, according to an aspect. The images of the documents may be uploaded from a user's mobile device 545 for processing to a third party company 307 for authentication. Generally, the app is configured to receive images of a signer and the signer's identification documents, and send these images to a third party 307 for authentication. Generally, sending the images is performed via an online network 308, such as to a cloud-based third party 307. In such embodiments, the third party can then perform the necessary algorithms for verification and authentication, and send the results back to the application. Once authentication is complete, the person's information is uploaded to a digital transaction log. The information may include address, phone number, email address, and so on. Such information can also be verified and authenticated against global databases stored in the centralized database of the secure notary system, wherein any suitable databases may be used by the third party. For example, global databases, accessible by any suitable user, may be databases stored outside of the secure notary system, whereas centralized database of the secure notary system is used only for storage of the system's own completed notarizations. Generally, the bar code reader function of the system (discussed in further detail herein) may allow approved partners of the system to access the centralized database for verification of any notarization completed on the secure notary system platform.

Identity proofing may be performed to various levels. As an example, proofing to a minimum level 2 may be required by the system. Then, once the information is verified, the information is uploaded to the digital transaction log of the system for secure storage. In some embodiments, a secured digital transaction log may be provided in the secure notary system. In such embodiments, the secured digital transaction log may be used for safely and securely storing documents, and any other information related to the notarization.

Accordingly, the secure notary systems disclosed herein may be provided with a variety of methods for ensuring authenticity of documents, items, and persons using the application for accessing the secure notary systems, including notaries and person who are signers of documents, for example, but may not be notaries themselves.

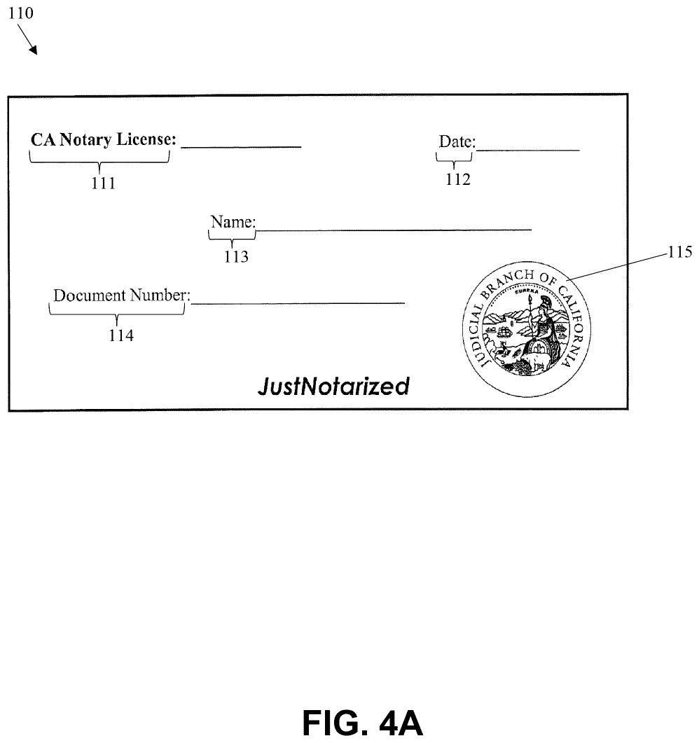

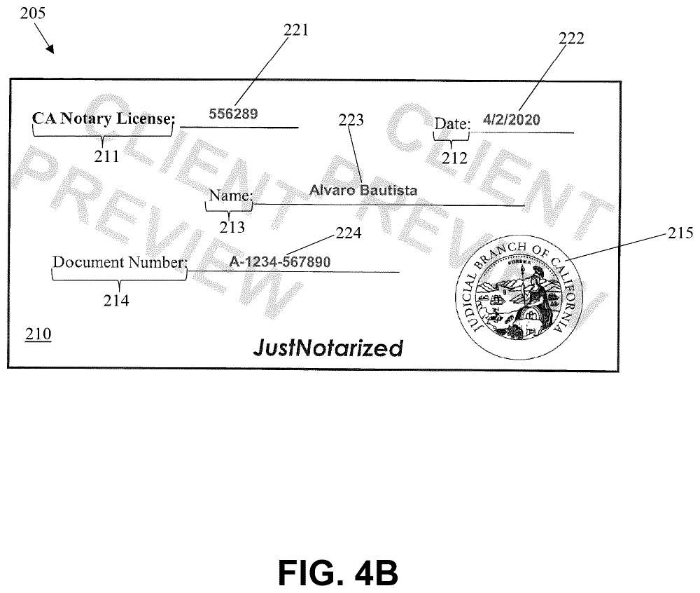

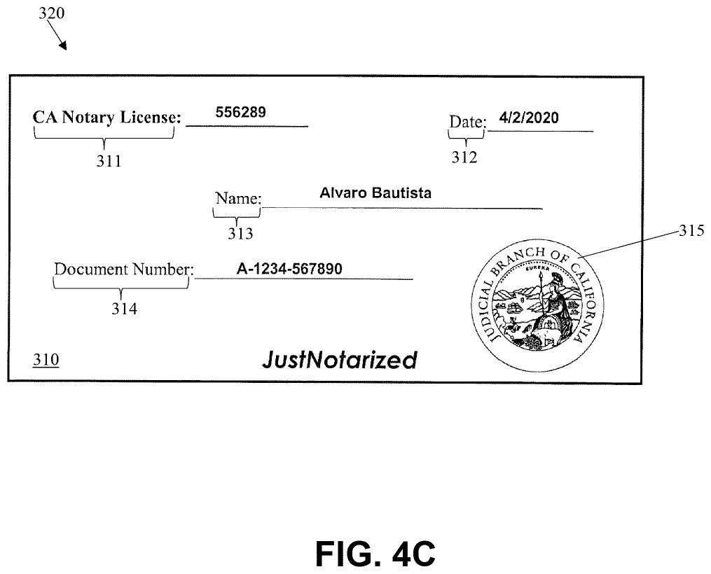

FIG. 4A is an exemplary blank notary endorsement 110, according to an aspect. The notary endorsement (“notary endorsement,” “notary sticker,” “notary endorsement sticker,” “notary acknowledgment”) 110 may be provided as part of the notarization mobile applications disclosed herein.

As is known, the purpose of the notary endorsement/acknowledgement is to provide a visible indication (usually in the form of a stamp) that the notary ensured that the signer of a particular document is indeed the person named in the document. As shown as an example, the notary endorsement 110 may initially be provided in a blank state (“blank state,” “unfilled state,” “empty state”) and may be auto generated and subsequently filled in/populated by the notarization program, which will be discussed in detail later.

As will be described throughout this disclosure, the auto-notarizing program may be utilized by a notary/notary public for assistance in securely and efficiently notarizing a document. As shown as an example in FIG. 4A, the notary endorsement 110 may display the license number 111 of the notary/notary public, the date 112 the document was notarized, the name of the identity-verified notary 113, and a unique document identification number 114, according to the details required by the State Notary Commission. The unique barcode may be generated and assigned by the notarization program for archival and retrieval purposes, as an example, which will be discussed in further detail later. As shown, the notary endorsement 110 may also be provided with a seal 115 indicating the state in which the notary operates. As an example, a notary endorsement for a notary operating in the state of California (CA) is shown in FIG. 4A, as indicated by the seal 115. It should be understood that the notary endorsement 110 is provided as an example, and, depending on the state in which the notary operates, the notary endorsement 110 and the seal 115 may be different. Furthermore, a seal need not be provided on the notary endorsement 110, as an example, and the notary endorsement 110 may visually differ and include more or less information than that shown in FIG. 4A.

FIG. 4B is an exemplary preview 205 of a notary endorsement 210 generated by an auto-notarizing mobile application, according to an aspect. As mentioned previously above when referring to FIG. 4A, the notary endorsement 110 may be provided as part of the auto-notarizing mobile application, which may be utilized by a notary (the user). The notary's license number, which is verified by the notarization program, may be provided on the notary endorsement. During use, as will be described in further detail later in this disclosure, the notarization program may digitally verify the signatory's identity, and then the notary may visually verify said identity. The notary's identity may be provided on the notary endorsement as well, as mentioned previously above.

As shown as an example in FIG. 4B, the notarization program may automatically generate a completed notary endorsement 210, upon the signer's execution of a document. As shown, the completed notary endorsement 210 may illustrate the notary's license 211, which in this particular example is shown at 221 as ‘556289.’ The notary endorsement 210 may also display the date the notarization took place, indicated by 222 in this example. Furthermore, as mentioned above, the notary's name may be provided, as shown at 223, and finally, the document number 214 may be provided as well. In this example, the document number 224 may refer to a deed of full reconveyance, which will be referenced again later in this disclosure.

As an example, the completed notary endorsement 210 may be first generated as a preview, as indicated by 205. The preview 205 of the completed notary endorsement 210 may be displayed on a mobile device screen (e.g., a cellphone screen) on which the notarization program operates, as an example. The preview 205 of the completed notary endorsement 210 may serve as an indicator that certain information, like the notary's license ID (‘556289’) 221 and the notary's name (‘Alvaro Bautista’) 223, has been accurately (or inaccurately) captured, as an example. Should the information populated into the notary endorsement 210 not be accurately captured, for example, the notary may correct the inaccuracy by manually typing into the appropriate field(s) (e.g., 213, 214, etc.) via the notarization program operating on the mobile device. More than one notary may utilize the same mobile device, for example, such that to utilize the notarization program, which will be discussed in greater detail later. As such, the preview 205 may enable each such notary to confirm their respective information.

FIG. 4C is an exemplary sticker 320 illustrating a finalized notary endorsement 310, generated by the auto-notarizing mobile application, of that shown in FIG. 4B, according to an aspect. As mentioned previously above, the notarization program may generate a preview of the completed notary endorsement (shown by 205 in FIG. 4B) for the user to check for accuracy. Once the information provided on the notary endorsement has been visually approved by the notary, as shown in FIG. 4C, the notarization program may generate a finalized version 310 of the completed notary endorsement, which may be digitally saved for future use as a notarization sticker/label 320 during the notarization process.

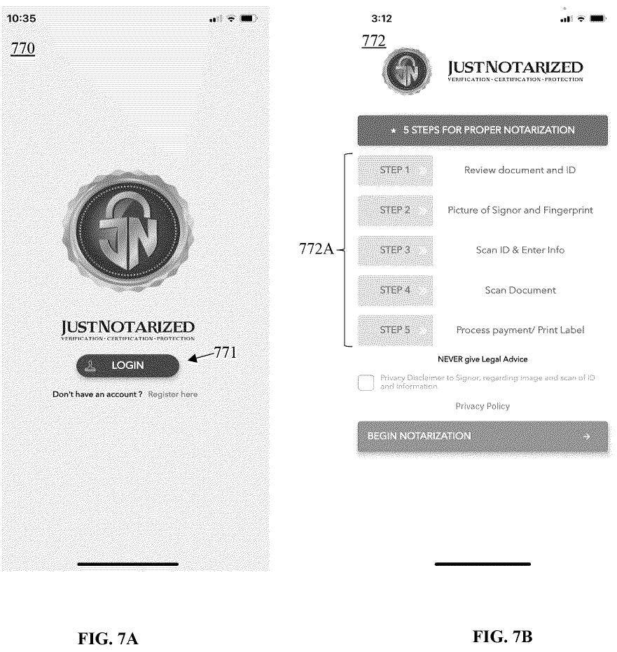

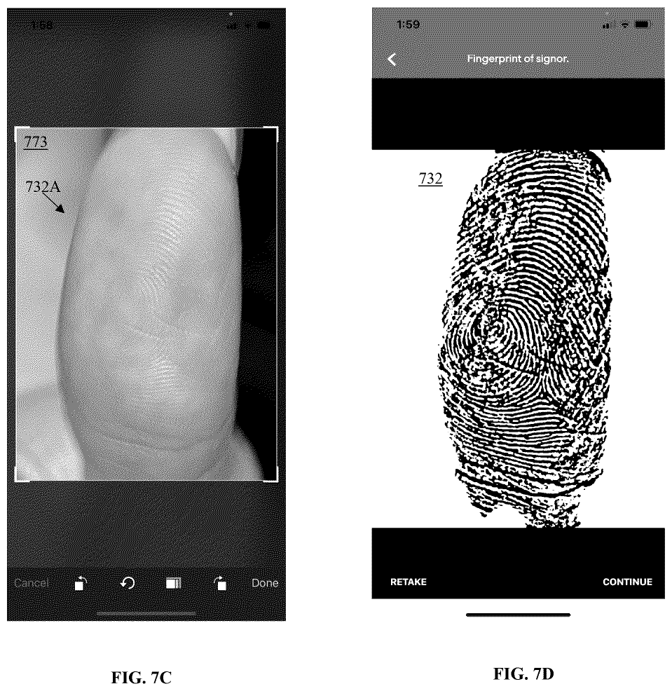

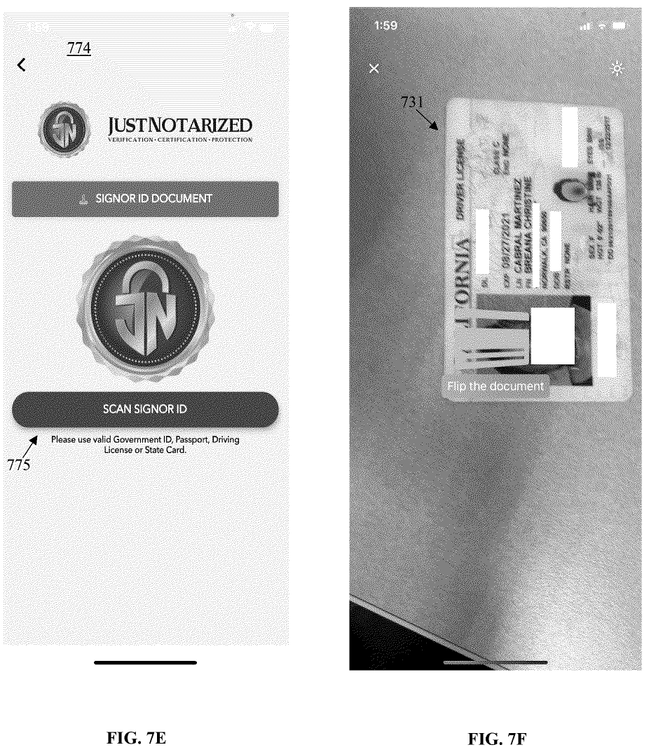

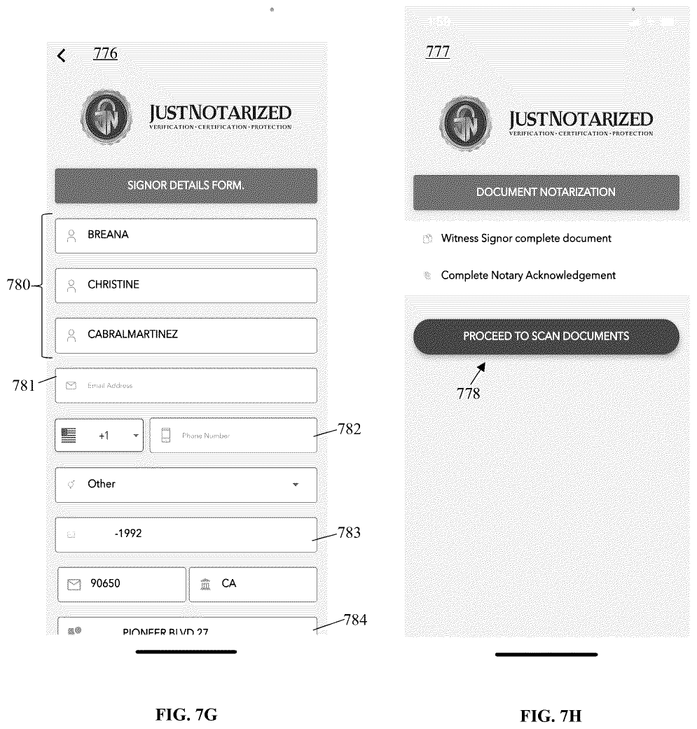

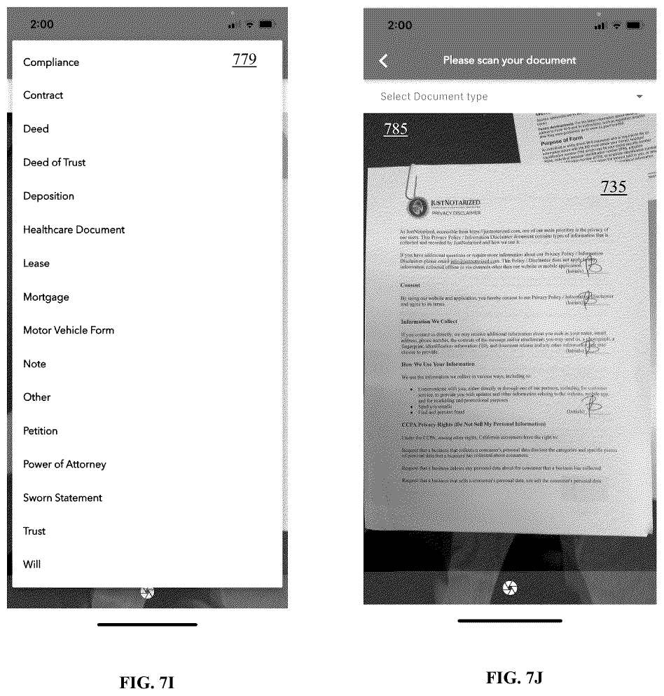

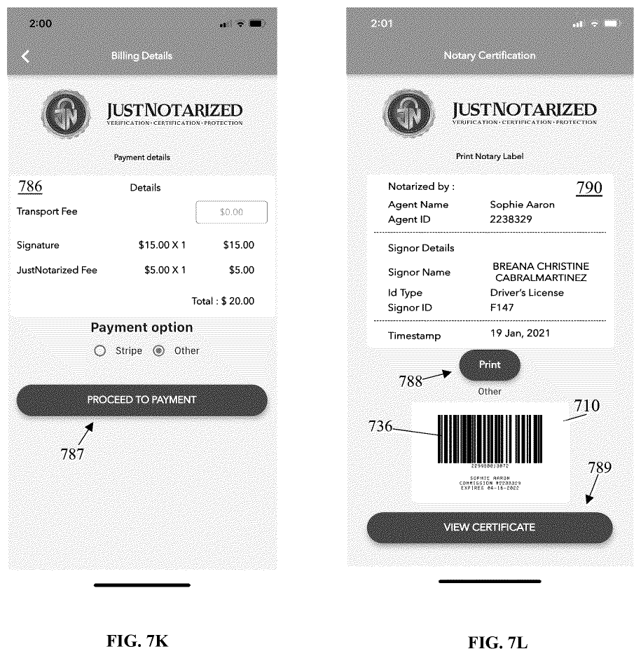

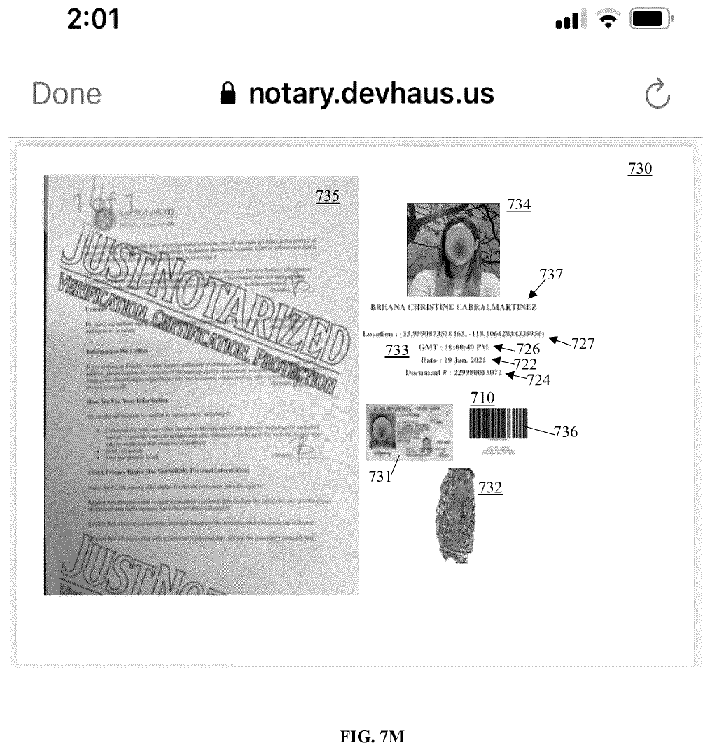

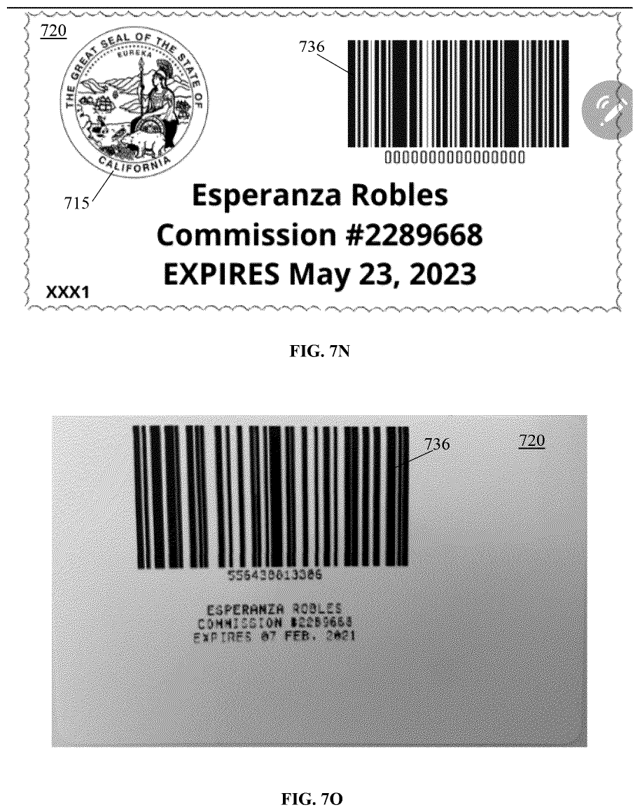

Again, the notary endorsement may include the notary's license number 311, the date of notarization 312, the name of the notary 313 and the document number 314, as shown as an example, according to the requirements by the State Notary Commission. As an example, the notary endorsement may also include a unique proprietary barcode, in substitution of or in addition to, one or more of the above-listed information. An example of such a barcode is shown in FIGS. 7N-70, for example. Thus, the notary acknowledgment sticker 320 may function as an effective notary stamp, as is used commonly in the field.

It should be understood that the sticker 320 can be uniquely/selectively configured to meet each state's respective requirement for approved use. On the other hand, the label/sticker 320 can also be used internally at a notary's place of work as a marker, for example, to be used in states that do not adopt the disclosed notarization application. As such, the secure notarization application can be used alongside/cooperatively with a notary's process, who may continue using traditional notary stamps (e.g., ink stamps).

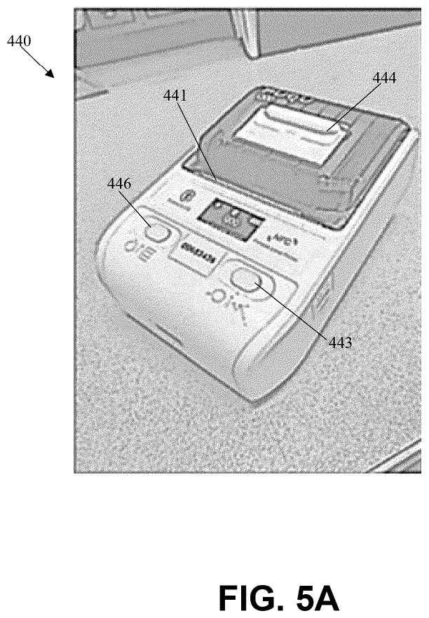

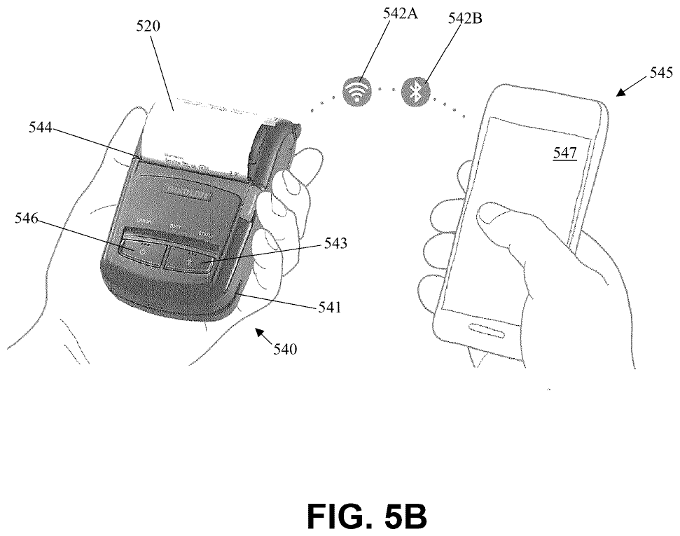

FIG. 5A illustrates a perspective view of an exemplary notarization device 440, according to an aspect. As described previously throughout this disclosure, the notarization program may be provided to assist the notary with the notarization process, to verify the identity of the signer and the qualifications of the notary, such that to avoid instances of notary fraud, and to provide a source and means for archiving the notarized documents. In accordance with an aspect of the current invention, the notarization program may be provided with the exemplary notarization device 440, as shown in FIG. 5A.

As shown, the notarization device 440 may be a relatively small, handheld device that may be used by the notary. Thus, an advantage is that the notarization device may be lightweight and easy to carry around, providing the notary with free mobility during use, and thus easy retrieval for use during the notarization process. As an example, the notarization device 440 may function as an input and output means for the notarization program, which may operate on a mobile device, as will be described in detail when referring to FIG. 5B. As shown in FIG. 5A, the notarization device 440 may comprise a card reader 441, in the form of a card slider and/or a chip reader, as an example. As an example, the notarization program may read and digitally verify a signer's identification card (e.g., a driver license) and/or accept payment solutions (e.g., debit or credit cards) via the card reader 441. As shown, the notarization device 440 may further comprise a fingerprint scanner (not shown). As an example, the JustNotarized app may scan and record the signer's fingerprint via the fingerprint scanner. As an example, the notarization device 440 may also be provided with a printer 444, as shown in FIG. 5A. As an example, the printer 444 may be a thermal printer. As will be discussed in further detail below, the notarization program may print the notarization endorsement (shown by 310 in FIG. 4C) via the thermal printer 444, as an example.

The notarization device 440 may further comprise a power button 446 and a small Bluetooth® chip (not shown) or wireless receiver/transmitter (not shown) for wirelessly pairing the notarization device 440 to another wireless compatible device (e.g., smartphone) via pairing button 443, as an example. As an example, the notarization device 440 may be battery operated, such that the device comprises a disposable battery or a rechargeable battery associated with an external charging cable (not shown), for example. As shown, the notarization device 440 may be provided with a compact design, allowing for multiple functionalities on a single device. Thus, an advantage is that the notary may accomplish multiple tasks in accordance with the notarization process using a single, compact device. It should be understood that the notarization device 440 shown in FIG. 5A is an example and the overall design and appearance of the notarization device may be different, with the same functionalities captured in various embodiments. As mentioned above, the notarization device 440 may be paired with the notarization program via a mobile device, which will be described in greater detail below.

FIG. 5B illustrates a front perspective view of an exemplary notarization device 540 connected wirelessly to a mobile device 545, according to an aspect. As shown, another exemplary embodiment of the notarization device is depicted in FIG. 5B. Again, the notarization device 540 may be provided with a power button 546, a card reader 541, a pairing button 543 and a printer 544, from which a sticker (“sticker,” “stamp”) 520 may be printed, as shown as an example. As shown in FIG. 5B, the notarization device 540 may easily fit within the palm of a user's hand, allowing for ease and mobility of use, as similarly mentioned above when referring to FIG. 4.

As mentioned previously above, the notarization device 540 may be paired with the notarization program via a mobile device (e.g., cellphone, tablet) 545. The pairing of the notarization device 540 and the mobile device 545 form a system for auto-notarization in accordance with an aspect of the current invention. The notarization app may be run and operated on the mobile device 545, such that the notary operates both the notarization device 540 and the mobile device 545 simultaneously, as shown. As shown in FIG. 5B, the notarization device 540 may connect wirelessly to the mobile device 545 via Wi-Fi 542A or Bluetooth® 542B, as an example. When wirelessly connected to the mobile device 545, the notarization device 540 functions as part of the notarization program's input means (via the card reader 541 and fingerprint scanner, for example) and may also function as part of the notarization program's output means (via the printer 544, for example). The mobile device 545 may further function as parts of the notarization program's input and output means, via the mobile device's screen 547 and camera (not shown), for example. The notarization device 540, the mobile device 545, and the notarization program operating on the mobile device 545 may thus function effectively as a notarization system, according to aspects of the current invention.

It should be understood that because of the wireless capabilities of the notarization device 540, the device may be paired with other wirelessly compatible devices, such as smart televisions, smart watches, laptops, or desktops, for example. Thus, an advantage is the ease of incorporation of the notarization device and notarization program with existing wireless devices, which may thus reduce operational costs.

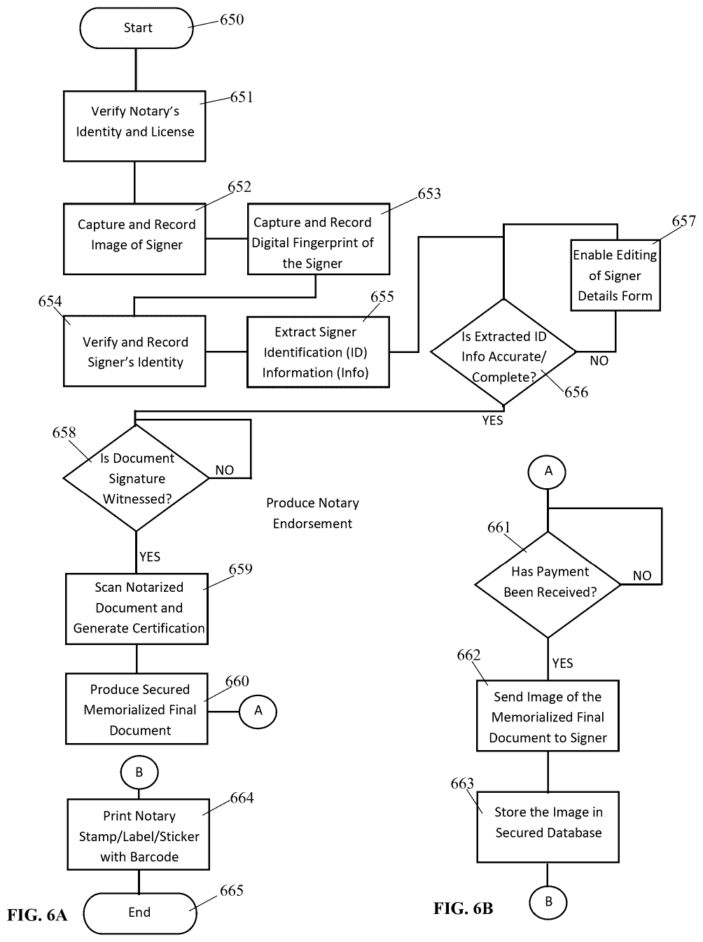

In accordance with an aspect of the present invention, a method of notarizing a document is provided. The method, which will be described hereafter, may be provided with the auto-notarizing system described above, particularly the notarization device and the notarization program operating on the mobile device, as an example. The method may comprise steps of using the notarization device and may also comprise the process steps taken automatically by the notarization program, which will be discussed in further detail when referring to FIGS. 6A-6B. It should be understood that the notarization program may be programmed and designed in software that will run as a downloadable mobile application on the mobile device, as illustrated in FIGS. 7A-7M.

FIGS. 6A-6B are flowcharts illustrating the auto-notarizing mobile application process steps of notarizing a document, according to several aspects. As is known in the art, the services of a notary/notary public may be utilized for witnessing the signing of documents and certifying the authenticity of said documents, as described previously in the Background above. According to the provided method of notarizing a document, to be described below, a primary user, which in this example is the notary, may utilize the notarization system comprising the notarization device (e.g., 540) and the notarization program operating on the mobile device (e.g., 545), both shown previously in FIG. 5B.

FIGS. 7A-7O are exemplary screenshots illustrating a method of notarizing a document using the auto-notarizing mobile application described in FIGS. 6A-6B, according to an aspect. As mentioned above, a method of notarizing documents may be provided to guide notaries/notary publics in securely and efficiently using the disclosed notarization application. As an example, let the primary user be a licensed notary and let the secondary user be a signer of a document-to-be-notarized (shown by 735 in FIG. 7J, for example), as mentioned previously above.

Referring to FIGS. 6A-6B and to FIGS. 7A-7O, first, after startup of the notarization program (shown by 650), the authorized primary user, who may be the notary as mentioned above, may access the notarization program by logging into the notarization application via the startup page 770 (shown in FIG. 7A). At login 771, as shown in FIG. 7A, for example, the notary may input his or her username and password (or register for an account) to access the application and may subsequently verify his or her identity using biometrics screening (e.g., facial recognition and/or fingerprint via the mobile device camera). As an example, the notarization program will be pre-installed (i.e., downloaded and running) on the notary's mobile device. To verify the notary's qualifications, and before giving full access to the notary, the notarization program will screen the notary's license ID (shown by 651 in FIG. 6A) through the state database (e.g., California's notary database), the Department of Motor Vehicles database, and/or a list of known notaries to confirm authorization to use the notarization program, for example. Then, upon the program confirming identity and existence of a valid notary license, the notary is given access to the mobile application's Home screen 772, from which the notary may proceed with the Notarization process for the present signer. It should be understood that the notarization program will verify the notary's identity and validity of the notary's license with the Secretary of State before each notarization. The notarization program will thus not begin full operation until a successful biometric identification has been achieved. Thus, an advantage of the disclosed method is that notary fraud on the part of the notary may be effectively avoided.

As an example, an e-log (“e-log,” “electronic log,” “electronic journal”) (not shown) may also be provided in the application to allow the notary a means of keeping a written record of the notary's official acts. As such, the e-log may function as an equivalent to, and thus a replacement of, the notary's physical journal, as is typically used by notaries. The e-log may utilize Blockchain Technology, depending on the rules and regulations of each jurisdiction, for example, to amalgamate and thus secure the data kept in the e-log. As mentioned above, it should be understood that the notarization application may incorporate the mobile device's camera (e.g., cellphone camera), such that to scan the identification card presented. As such, the notary may selectively use either the card reader of the notarization device or the device's built-in camera. In either case, the notarization program will digitally scan and verify the signer's identification in real time. For simplicity, it may be preferred to scan the identification card using the built-in camera, as opposed to the card reader of the notarization device.

As shown in FIG. 7B, the Home Screen 772 of the auto-notarizing app (“auto-notarizing app,” “application”) may produce a detailed step by step process (“process,” “notarization process”) 772A for the notary to follow to complete the notarization (displayed on the mobile device screen, for example). Step 1, as indicated by 772A, may involve the visual review of the document-to-be-signed (e.g., 735 in FIG. 7J) and the visual review of the signer's identification card by the notary. Upon physical inspection and approval of the document-to-be-signed and the identification card, the notary may take a photograph of the signer (using the camera on the mobile device, for example), as indicated at Step 2 in FIG. 7B, which may be recorded as an image in the notary's personal e-log (shown by 652 in FIG. 6A). The notary may then take a digital scan 773 of the signer's fingerprint 732A, as shown in FIG. 7C, in accordance with Step 2 of the notarization process 772A, and a propriety program within the application will then produce a digital image (e.g., a line drawing) 732, shown in FIG. 7D, of the fingerprint 732A, which will also be stored in the e-log for record-keeping (shown by 653 in FIG. 6A). The signer's fingerprint may be read using the fingerprint scanner on the notarization device or the camera of the mobile device, for example. The recorded photograph and fingerprint image of the signer may help protect against instances of future identity theft, as an example. It should be noted, for example, that the application may produce and display a disclosure statement for the signer to agree to recordation of the signer's identification information (shown in FIG. 7B, for example).

Following the recordation of the signer's photograph and fingerprint scan 732, the notarization application must then digitally verify the signer's identity (shown by 774 in FIG. 7E), which can be done via the card reader on the notarization device or the camera of the mobile device. As shown in FIG. 7E, the notarization application will prompt (at 775) the notary to scan the signer's identification card. An acceptable identification card may be a passport, driver license, State ID card, etc., which may be swiped within the card reader or scanned using the camera, as an example. As shown in FIG. 7F, the notary may then take a digital scan of the signer's identification card, which in this example is a California Driver license 731. A proprietary third-party program within the application will then digitally read the provided proof of ID and verify the signer's identification card against a global database (and/or the DMV database) to ensure authenticity of the ID card and validity of the signer's stated identity (shown by 654). Upon verification of the signer's identity, the application will save a copy of the ID image for use later (shown by 654). As shown in FIG. 7G, the application may also extract the signer's identification information, such as the name 780, date of birth 783, and residence 784 of the signer, using the ID image (via suitable image extraction software), shown by 655 in FIG. 6A, which may be saved in the notary's e-log. Additionally, as shown in FIG. 7G, the application may prompt the notary to obtain additional signer information (shown by 656 in FIG. 6A), such as email address 781 and phone number 782, for example. Thus, an advantage is that the signer's identity may be automatically verified using the disclosed method, which may prevent instances of notary fraud.

As mentioned above, the notarization program may extract the signer's information to auto-populate the notary's e-log, for example, which may be edited as needed (as shown by 657). Once the signer's personal information and contact information have been obtained, as described above, the notary may proceed to notarizing the document, as indicated by 777 in FIG. 7H. In accordance with notarization practices, the notary must verify that the signer is the individual named in the document, at which point, the signer may then sign the document while the notary witnesses (as shown by 658). Following the notarization of the document, the notary may proceed to scan the signed/notarized document via the camera of the mobile device, as indicated by 778 in FIG. 7H. As shown in FIG. 7I, the notary may be prompted to select the type of document that has been notarized from a list 779 of the most common documents, or the notary may simply select “Other” from the document type list of options, should the document type in question not explicitly be listed, as an example. Once the notary identifies the document type, the application will allow the notary to scan the signed document 735, as shown by 785 in FIG. 7J and by 659 in FIG. 6A. The scanned document is digitally fitted into a final document (shown by 660), which will be described in greater detail below when referring to FIG. 7M.

Referring now to FIG. 6B, following the generating of the final document (730 in FIG. 7M), the auto-notarizing mobile application will await payment for the notarization services provided by the notary (shown by 661). As shown by 786 in FIG. 7K, the notary may update the payment cost to include mileage fees and/or other signing charges, for example, under ‘Transport Fee.’ As an example, the application may allow the signer to pay for the notary service in a number of ways, such as using debit/credit cards via the card reader/chip reader on the notarization device, Apple® Pay, wireless tap card, etc. Upon the receipt of payment, as indicated by 787 in FIG. 7K, the notarization program digitally sends an image of the memorialized final document (730 in FIG. 7M) to the signer (shown by 662 in FIG. 6) for their records, for example. The image of the final document may be digitally sent to the signer via text or email, for example, which was obtained from the signer previously (see e.g., 776 in FIG. 7G). The actual image may be electronically sent or an electronic link to access the image may be electronically sent to the signer, for example.

As shown in FIG. 6B, the application may then store the document (730) on a secure cloud-based server or database (shown by 664) for future retrieval by authorized individuals. The cloud-based server may be any suitably secure web-based storage service, such as Amazon® Web Services, Apple® iCloud, or Google® Cloud, for example. Authorized users (i.e., vetted, and qualified users) may subscribe to the secured database to access document information and retrieve copies of their notarized documents, for example. Access to the database will be limited, however, and shall be secured via a multi-step authentication process, including biometrics screening. Moreover, the digital copies of the notarized documents will be accessible via a barcode reader device or a dedicated HIPAA compliant JustNotarized website (e.g., website having a dedicated IP address verification), as an example. It should be noted that the notary (i.e., the app holder) will not be given access to the secured database. The notary may access their e-log for recorded details regarding particular notarizations. Thus, the notarized documents may be digitally memorialized and securely stored for the signer to later access. It should be understood that the files stored on the secured cloud database may be accessed by third parties given authorization to access the documents, or by the public if the notarized documents are in fact public records. However, the public will not have access to such documents through the JustNotarized website, as the notarization application does not record any private information onto any publicly available websites, as an example.

Finally, as shown in FIG. 6A, the notarization application may print a notary sticker/label (shown by 664) having a generated notary endorsement, which was described in detail previously when referring to FIGS. 1-3 above. As shown in FIG. 7L, the notarization application may present a notarization summary 790 for the notary to review, as well as the generated notary endorsement 710. As shown, the notarization summary 790 may include the notary's license number, the date of notarization, the name of the notary, as well as the signer's details, which were electronically obtained by the notarization program previously. The application may digitally provide the notary endorsement 710 with a unique proprietary barcode 736, mentioned previously above. Once the notary visually confirms the accuracy of the information displayed in the summary 790, the notary may wirelessly transmit he notary endorsement 710 to the notarization device (via 788 in FIG. 7L). The notary endorsement 710 may then be automatically printed by the notarization device via the thermal printer onto a tamper-resistant security sticker 720, as shown in FIGS. 7N & 7O, which may subsequently be associated with the signed document by the notary. It should be understood that the notary endorsement sticker may be associated with the notarization document in a number of ways, such as, for example, affixing the sticker onto the document, imprinting the sticker into the document, printing the document having the sticker, among others. The notary may then sign the document and associate the document with the notary sticker 720 (shown in FIGS. 7N & 7O), legitimizing and officiating the notarization. As indicated in FIG. 7L at 789, the notarization program may allow the notary to view the final document 730, which will be described in detail below.

As mentioned previously above when referring to 7J, the scanned notarized document 735 may be incorporated into a final document 730, a copy of which was securely electronically sent to the signer. As shown in FIG. 7M, the notarized document 735 is conjoined within the final document (“final document,” “finalized PDF,” “memorialized final document”) 730 with a digital copy of the signer's ID 731 (the ID card presented to the notary), an image of the signer 734 (captured previously), and a digital line drawing of the signer's fingerprint 732. As shown previously in FIG. 7G, in this example, the signer is Breana Christine Cabral Martinez. As shown in FIG. 7M, the final document 730 may clearly display the notarized document 735 having the signer's signature and the notary's signature and may also display the notary endorsement 710. As described previously in this disclosure, the notary endorsement 710, like a traditional notary stamp, may include the notary's license number, the date of notarization, and the name of the notary, as required by the State Notary Commission. The notary endorsement label 710 may further comprise a unique barcode 736 for quick identification of the notarization and the signer details, for example, which may provide further security to the record of the notarized document.

Finally, as shown in FIG. 7M, the finalized PDF 730 may further comprise a document certificate (“document certificate,” “JustNotarized certification,” “certification,” “certificate of notarization”) 733 and watermarks (not shown) layered as the image is flattened (e.g., PDF/A compliant) and thus secured. As shown, the certification 733 may clearly label the GPS location 727 where the notarization took place (given as latitude and longitude), the date 722 on, and the time 726 at, which the notarization took place, and a copy of the unique document number 724 (determined upon selection of the document type). Thus, the certificate of notarization 733 may certify the electronic copy of the notarized document 735 contained in the final document 730, such that the notarization may be memorialized.

It should be understood that, as described previously above, the notarization application may be configured to digitally generate and print notary endorsement stickers with or without a particular state's seal. As shown in FIG. 7N, the notary endorsement sticker 720 may include the state seal 715 (e.g., California's state seal), as well as the unique barcode 736 and notary information, described previously above. Alternatively, as shown in FIG. 7O, the notary endorsement sticker 720 may omit the state seal, and solely display the unique barcode 736 and notary information (e.g., name and license number). As mentioned previously above, the inclusion of the seal and the type of the notary endorsement sticker used with the notarization program depends on the state in which the notary practices and that state's specific requirements, for example. Furthermore, it should be understood that the notarization application may generate and print a notary endorsement having only a unique barcode (e.g., 736), the unique barcode thus digitally encoding all the above-mentioned notary details.

Thus, an advantage of the disclosed method is that notarized documents and notary logs may be securely archived and remain available for later access. Another advantage is that a document may be securely and efficiently notarized and digitally saved in a single secured database, ensuring notarization information remains memorialized. An additional advantage is the reduction in cases of notary fraud due to improved, instant third-party verification of notary and signer identities. Because the notarization program automatically generates the notary endorsement and the notarization certification, another advantage is the addition of fail safes to the overall notarization process. An additional advantage is that, because the final document is provided as a flattened secured image, no alterations may be done to the final document after the notarization is completed, which may prevent the forging of notarized documents.

The notarization program, for example, may allow multiple page documents to be notarized, not just single page documents, within a single transaction. The application may also include a timer/time-out function, for example, that limits the duration of a notarization session. As such, the timer function may begin tracking/timing the notarization process after notary verification (i.e., the first step of the process) and may automatically log off the session after a certain amount of time has transpired. The time period may be preset and/or edited within the application to accommodate longer notarization sessions (e.g., notarization of multiple page documents), as an example.

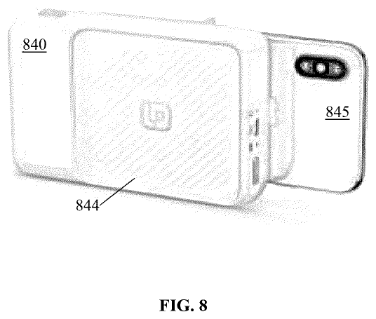

It should be understood that the above-listed and described steps may be taken or occur interchangeably, particularly with reference to the verification of the signer's identity and recordation of the signer's fingerprint, for example and/or acceptance of payment. It should also be understood that the provided notarization system may be adapted into a single standalone device. As an example, the standalone notarization device may comprise the notarization program, along with the power button, card/chip reader, printer, and display screen with a scanner camera. It should also be understood that the standalone notarization device may need to be larger in size and appearance to provide room for the necessary electrical hardware and additional components. It should also be understood that the notarization device may print the notary endorsement directly onto the signed document, rather than using a label, as shown as an example in FIG. 8.

FIG. 8 illustrates a front perspective view of an alternative embodiment 840 of the notarization device 440, provided as an attachment for a mobile device 845, according to an aspect. As shown in FIG. 8, this alternative embodiment 840 may attach directly to the mobile device 845 via a direct attachment (e.g., via a magnet or adhesive) or via a slidable engagement. The notarization device 840 may wirelessly communicate with the mobile device 845, such that to communicate with the notarization application in the manner described throughout this disclosure above. It should be understood that the embodiment 840 may comprise the same or additional/fewer components than the previous embodiments shown and described. Finally, the notarization device 840 may comprise a digital printer 844 adapted to print directly onto a surface, rather than printing a sticker/label, as described previously. The digital printer 844 may, like a traditional ink stamp, for example, print the notary endorsement directly onto the signed document, in accordance with the disclosed notarization process.

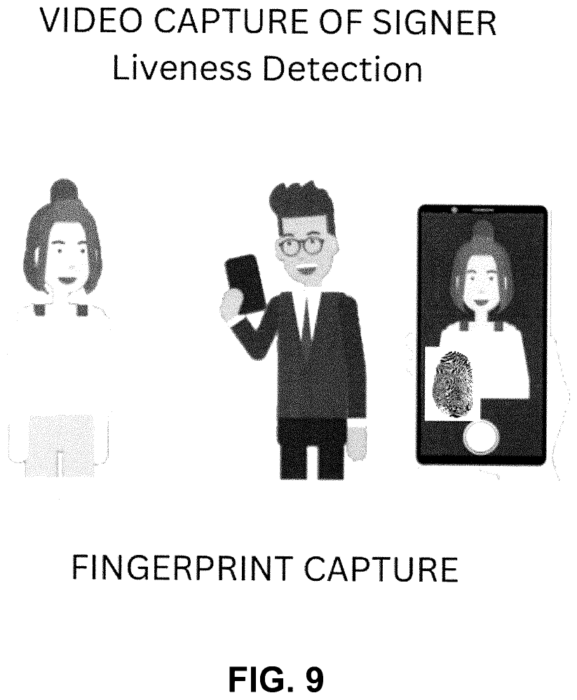

FIG. 9 is a depiction of an exemplary process for verification of a person's identity using the secure notary system, according to an aspect. Further to the verification methods such as those discussed when referring to at least FIGS. 7C-7D, the secure notary systems disclosed herein may include processes for capturing and recording live video. The live videos may be stored in the digital transaction log of the system. In some embodiments, an electronic journal is available to users if permitted by the particular state by which the user is operating. A unique program within the application can capture a digital fingerprint image from a picture taken by the notary using the application, subsequently producing an outline drawing of the fingerprint (such as the example shown in FIG. 7D), which will also be stored in the digital transaction log. Images and fingerprint storage may only take place where it is state required and approved.

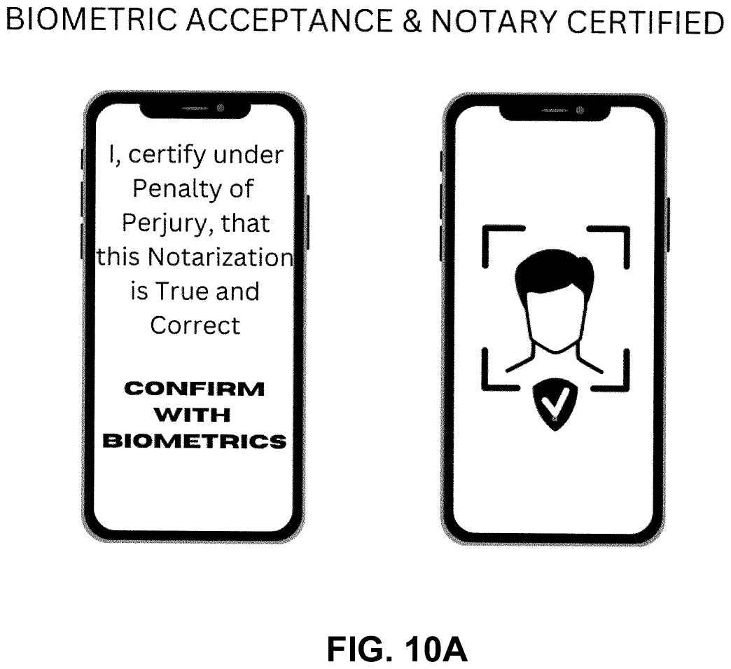

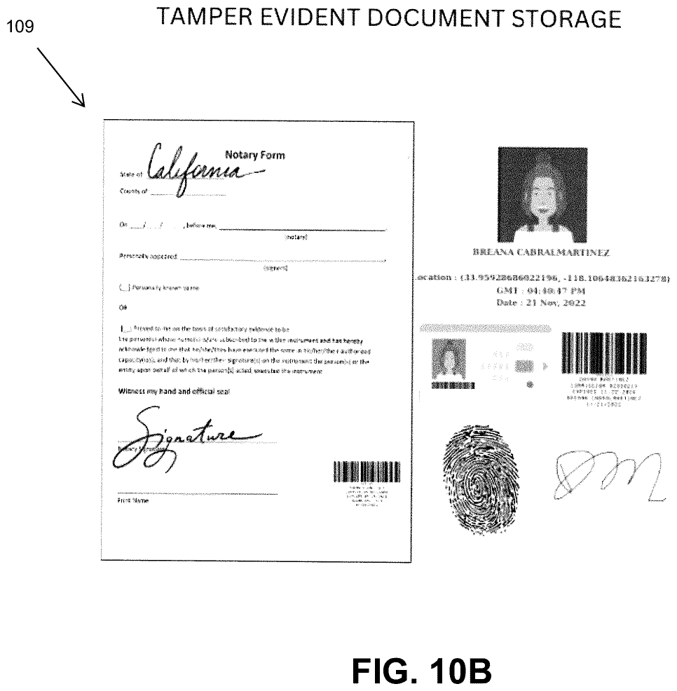

FIGS. 10A-10B show exemplary screenshots and documents relating to a biometric verification process using an application for the secure notary system, according to an aspect. After a notarial process such as verification of a signer's identity, signing of a document, and the like, the notary may stamp their notary seal onto the document, completing the traditional notarial process. The notary may then again verify their identity and certify that the notarial process was completed correctly, through biometric verification and acceptance. The signed document, along with fingerprint and identity information, will then be scanned and converted into a tamper evident image 109 that will be stored in the digital transaction log. Generally, this process may be performed by any suitable process, such as, for example, flattening an image and not allowing it to be altered without visually showing signs of alterations. In some embodiments, the application is configured digitally generate a memorialized final document, the memorialized final document being a flattened, watermarked, conjoined image displaying the notarized document, the certificate of notarization, a copy of the identification card, a copy of the digital line drawing of the fingerprint, and the notarization endorsement

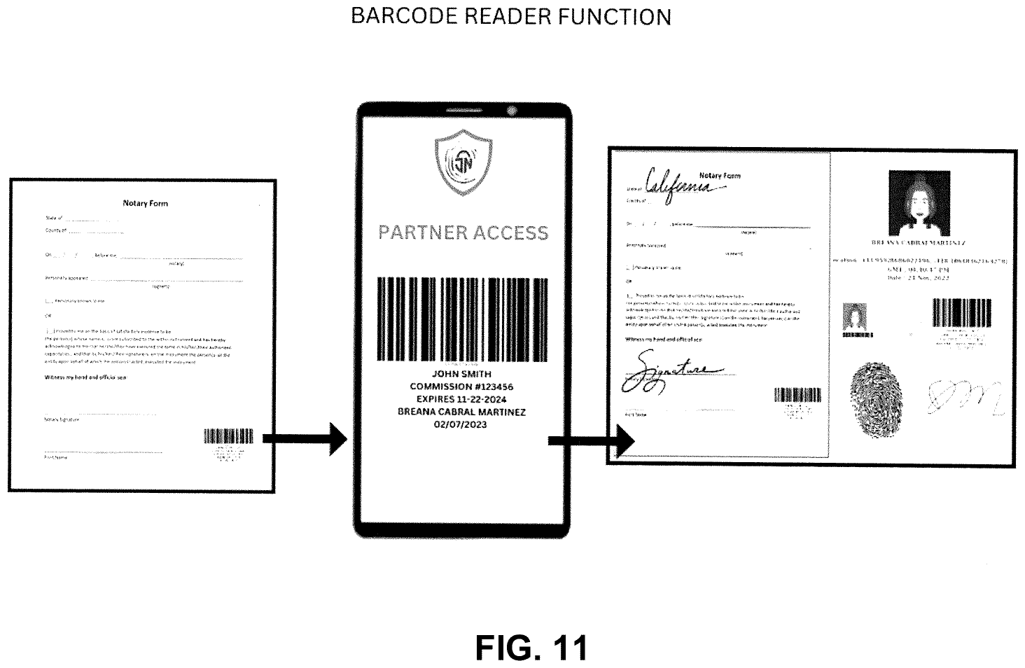

FIG. 11 shows an exemplary process for using barcodes with the secure notary system, according to an aspect. The application for the secure notary system may include functions for producing unique notary certificates for each document used in the system. The application may assign a unique barcode, QR code, or combination QR-barcode for every document that is notarized using the system. The unique identifier may generally be referred to as a “barcode” herein, but it should be understood that any suitable identifier such as a barcode, QR code, or combination QR-barcode may be used as needed. The unique barcode will allow for file retrieval through the application's research capabilities. The notary certification may contain a copy of the unique barcode along with the GMT time and geolocation of the signing event. The notary certificate will be printed onto a label, that can be affixed to the physical document. The notary certificate may also be printed directly onto the notarized document.

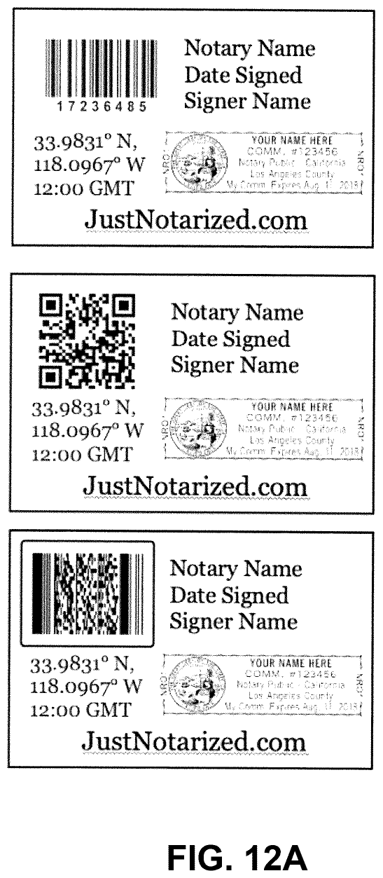

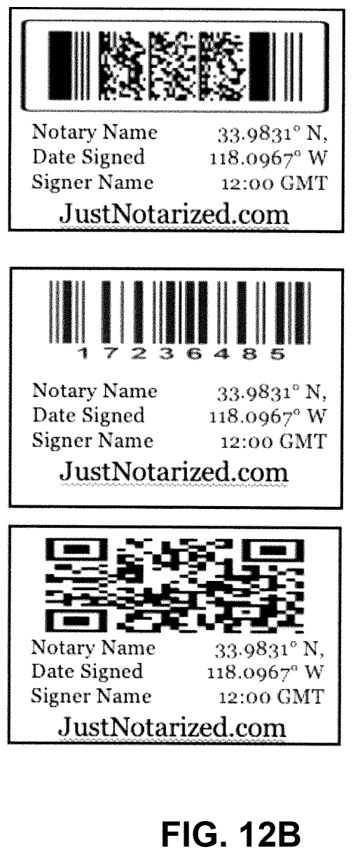

FIGS. 12A-12B depict various examples of barcodes that may be used for documents notarized with the secure notary system, according to an aspect. In some embodiments, users can only retrieve certain files by using the barcode assigned to the document, and using the barcode reader unique to the system.

In some embodiments, barcode scanner function is accessible to a user in the application only after the user is manually vetted and authorized to use the system. This user can then be referred to as an “authorized agent.” The vetting process may be similar to the notary vetting process, except for notary commissions being required for the process. The authorized agent may gain access to the application through biometric authentication. The authorized agent may have a unique barcode image available in order to access the notarization certification.

It should be understood that the notarization mobile application described herein above may be programmed and designed as a web-based, IOS-based, and/or Google-based mobile application. It should also be understood that the notarization mobile application may include visuals and written descriptions/steps to intuitively guide the notary in using the application and successfully completing the notarization process. It should be noted that the disclosed notarization mobile application may be designed to be HIPAA compliant, such that user access, and data security adheres to all required HIPAA protection protocols. For example, the notarization mobile application will not allow any form of screen recording (e.g., screenshot) of any recorded information during the notarization process. It should also be noted, as an example, that the authenticity of the signer's identification card may be established by a third-party authenticator using a global database, for example.

In some embodiments, the secure notary system may be useful for deterring or stopping the filing of fraudulent documents. As an example, the authenticity of a document may be determined by using the system. For example, the authentication may be performed prior to the recording of a document with a county clerk. In some embodiments, parties such as county clerks, courts, and other authorized parties may access the secure database of the secure notary system via the barcode reader function of the application.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

As used throughout this disclosure above and as recited in the claims, the phrase “mobile device” and its alternatives and/or derivatives are to be understood as meaning any piece of portable electronic equipment that can connect to the internet and wirelessly to other pieces electronic equipment, especially a smartphone, tablet, or laptop computer.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A secure notary system configured for assisting an authorized notary user, the authorized notary user having an active notary license status, with notarial processes, the system comprising:
a centralized database configured to store information relating to the notarial processes assisted by the secure notary system, the centralized database comprising:
a plurality of partitions, each partition configured to store information relating to a state within a state database, each state database comprising a list of known and licensed notaries in the state, or to store information relating to the notarial processes, or to store information relating to notary persons;
a notarization application configured to be accessible by the authorized notary user, and configured to operate on a mobile device having a camera, the notarization application being programmed to:
perform a verification process of the active notary license status by screening through the state databases of the centralized database, wherein the authorized notary user does not obtain authorized use of the notarization application until completion of the verification process of the active notary license status;
perform a verification process of an identity of the authorized notary user using a biometric identifier, wherein the verification process of the identity of the authorized notary user is performed to allow access to the notarization application on the mobile device; and;
perform a verification process of an identity of a signer prior to the signer producing a signed document during a notarization;
digitally scan and generate a digital image of identification documents of the signer and authenticate the identification documents by screening through a global database, the global database comprising a list of known and valid identification documents;
digitally scan and generate a digital image of a fingerprint of the signer;
digitally generate a notarization endorsement and cause a printing of the notarization endorsement onto a tamper-resistant sticker via an external device;
digitally generate a certificate of a notarization certifying a date on, a location at, and a time at which the notarization occurred;
digitally generate a memorialized final tamper-evident document of the certification of the notarization, the signed document, the fingerprint, and the identification documents for storage within the centralized database; and
digitally generate a unique bar code for each individual notarial process carried out using the secure notary system.

2. The secure notary system of claim 1, wherein the unique bar code allows an authorized user to access the memorialized final tamper-evident document.

3. The secure notary system of claim 1, wherein the unique bar code allows an authorized user to access information relating to time and location of the notarial process associated with the unique bar code.

4. The secure notary system of claim 1, wherein the verification process of the active notary license status is carried out by obtaining an image of license documents of the authorized notary user through the application, and sending the image to a third party for authentication.

5. The secure notary system of claim 4, wherein the verification process of the active notary license status further comprises manual confirmation of the active notary license status by a live person.

6. The secure notary system of claim 1, wherein the notarization application is configured for capturing and recording live video.

7. The secure notary system of claim 6, wherein the verification process of an identity of the authorized notary user and the verification process of an identity of the signer comprises video capture with liveness detection.

8. A secure notary system configured for assisting a primary user, the primary user having an active notary license status, with notarial processes, the system comprising:
a centralized database configured to store information relating to the notarial processes assisted by the secure notary system, the centralized database comprising:
a plurality of partitions, each partition configured to store information relating to a state within a state database, each state database comprising a list of known and licensed notaries in the state;
a notarization application configured to be accessible by the primary user, and configured to operate on a mobile device having a camera, the notarization application being programmed to:
perform a verification process of the active notary license status by screening through the state databases of the centralized database, wherein the authorized notary user does not obtain authorized use of the notarization application until completion of the verification process of the active notary license status;
perform a verification process of an identity of the primary user using a biometric identifier, wherein the verification process of the identity of the authorized notary user is performed to allow access to the notarization application on the mobile device; and;
perform a verification process of an identity of a secondary user, wherein the secondary user produces a signed document during a notarization;
capture and record live video;
digitally scan and generate a digital image of identification documents of the secondary user and authenticate the identification documents by screening through a global database, the global database comprising a list of known and valid identification documents;
digitally scan and generate a digital image of a fingerprint of the secondary user; and
digitally generate a memorialized final tamper-evident document of the signed document, the fingerprint, and the identification documents for storage within the centralized database.

9. The system of claim 8, wherein the primary user is a notary and the secondary user is a signer.

10. The system of claim 8, wherein the verification process of the active notary license status is carried out by obtaining an image of license documents of the authorized notary user through the application, and sending the image to a third party for authentication.

11. The secure notary system of claim 10, wherein the verification process of the active notary license status further comprises manual confirmation of the active notary license status by a live person.

12. The secure notary system of claim 10, wherein the notarization application is programmed to digitally generate a unique bar code for each individual notarial process carried out using the secure notary system.

13. The secure notary system of claim 12, wherein the unique bar code allows an authorized user to access the memorialized final tamper-evident document.

14. The secure notary system of claim 12, wherein the unique bar code allows an authorized user to access information relating to time and location of the notarial process associated with the unique bar code.

15. A method of assisting a notary with the notarization of a document, the method comprising providing a notarization application having an electronic log (e-log), the notarization application being programmed to:
verify the identity of the notary using a biometric identifier received via an operating device and validate a notary license number of the notary;
verify the identity of a signer by digitally reading and extracting identification information from an identification card of the signer, the identification card being received via the operating device, the extracted identification information being electronically stored in the e-log;
digitally scan and generate a digital image of a fingerprint of the signer, the fingerprint being received via the operating device, the digital image being electronically stored in the e-log;
digitally generate a notarization endorsement and cause a printing of the notarization endorsement onto a tamper-resistant sticker via an external device; and
digitally generate a certificate of notarization certifying a date on, a location at, and a time at which the notarization occurred.

16. The method of claim 15, wherein the notarization application is configured to be accessible only by the notary, and wherein the operating device is a mobile device on which the notarization application is configured to operate.

17. The method of claim 15, wherein the external device is a notarization device.

18. The method of claim 17, wherein the notarization application is further programmed to:
electronically store an image of the signer in the e-log, the image being captured via the mobile device;
digitally generate a memorialized final document using the e-log, the memorialized final document being a flattened, watermarked, conjoined image displaying the notarized document, the certificate of notarization, a copy of the identification card, a copy of the digital image of the fingerprint, and the notarization endorsement;
digitally process a payment card received by the card or chip readers of the notarization device; and
electronically send a copy of the memorialized final document to an electronic address provided by the signer and upload the copy to a secured cloud-based database.

19. The method of claim 15, wherein the biometric identifier is a facial pattern or a fingerprint.

20. The method of claim 15, wherein the notary license number is validated by screening through a state database, the state database comprising a list of known and licensed notaries in a particular state of practice, and the identification card is authenticated by screening through a global database, the global database comprising a list of known and valid identification cards.
